(19) United States
(12) Patent Application Publication
(10) Pub. No.: US 2008/0098459 A1
(43) Pub. Date: Apr. 24, 2008

(54) Systems and Methods of Network Operation and Information Processing, Including Engaging Users of a Public-Access Network

(76) Inventors: Jasminder Singh Banga, San Francisco, CA (US); Nitin Jayant Shah, Cupertino, CA (US); Brijesh Ramji Patel, Gilroy, CA (US); Amul Patel, Pacifica, CA (US)

Correspondence Address: COURTNEY STANIFORD & GREGORY LLP, P.O. BOX 9686, SAN JOSE, CA, 95157, US

(21) Appl. No.: 11/932,897

(22) Filed: Oct. 31, 2007

Related U.S. Application Data
(63) Continuation of application No. 11/387,651, filed on Mar. 22, 2006.
(60) Provisional application No. 60/664,322, filed on Mar. 22, 2005.

(51) Int. Cl. H04L 9/32; G06F 15/16

(52) U.S. Cl. 726/3; 709/217

(57) ABSTRACT

Systems and methods are disclosed for network operation and information processing involving engaging users of a network. In one exemplary embodiment, there is provided a method of engaging users of a public-access network. Moreover, the method includes associating a processing component with the public-access network; transmitting a request for authorization to use the public-access network, including transmission of a specific identifier associated with the user; transmitting first data including data determined by processing software as a function of the specific identifier; and opening up a connection to the network for the user. In one or more further embodiments, the specific identifier may include or be a function of a processing component ID or the MAC address of a device associated with the user. Other exemplary embodiments may include building profiles of users who access the network based on information collected.

### CROSS REFERENCE TO RELATED APPLICATIONS

Applicants claim the benefit of U.S. provisional patent application No. 60/664,322, filed Mar. 22, 2005, which is incorporated herein by reference.

### BACKGROUND

1. Field of the Invention

The present invention relates generally to systems and methods of network operation and information processing, and more specifically to systems and methods that involve engaging users of a network.

2. Description of Related Information

Existing systems for network operation and information processing typically engage users of a network without using or acquiring particularized information regarding the user, the user device, and/or previous usage information. The failure to use or acquire particularized information results in a variety of drawback for such systems, such as the need to charge for network access and the inability to deliver the most effective content. Further, the failure to acquire and subsequently process this particularized information can prevent such systems from delivering the most effective content throughout the entire engagement process or period.

For example, internet users often obtain information from content-rich sites on the web such as news related sites or portals that offer links to sites that offer the content users are seeking, or through search engines that scour the web to glean the information users seek. Vendors, ad-serving entities and web sites use a variety of techniques in a primary objective of delivering content that elicits a desired response from the recipient (e.g., content that includes one or more commercial activity motivating aspects, such as a revenue-generating feature). In this regard, the accumulation of information concerning the recipients or prospective recipients of the content encompasses numerous methods and technologies, including profiling, tracing usage, using markers to track behavior, etc. Drawbacks with these methods, however, oftentimes center around their inability to provide precisely targeted content and/or to inject appropriate localized content (e.g., advertising) directly into the various distributions or streams of information bound for each end user.

Therefore, a need exists for efficient, easy to deploy, adaptive learning systems that use and accumulate website-independent user-profile related information, and that are capable of updating, adaptively processing and delivering targeted content in real-time to an increasingly mobile computing community

### SUMMARY

Systems, methods, and articles of manufacture consistent with the invention are directed to network operation and information processing involving engaging users of a network. As seen in the specification below and the materials attached hereto, various embodiments of such systems, methods, and articles of manufacture are disclosed.

In one exemplary embodiment, there is provided a method of engaging users of a public-access network. Moreover, the method includes associating a processing component with the public-access network; transmitting a request for authorization to use the public-access network, including transmission of a specific identifier associated with the user; transmitting first data including data determined by processing software as a function of the specific identifier; and opening up a connection to the network for the user. In one or more further embodiments, the specific identifier may include or be a function of a processing component ID or the MAC (machine address code) of a device associated with the user. Other exemplary embodiments may include building profiles of users who access the network based on information collected.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of several further features disclosed below in the detailed description.

### BRIEF DESCRIPTION OF THE DRAWINGS

The accompanying drawings, which constitute a part of this specification, illustrate various embodiments and aspects of the present invention and, together with the description, explain the principles of the invention. In the drawings:

FIG. 1 is a block diagram of an exemplary computer system consistent with certain aspects related to the present invention.

FIG. 2 is a flow chart illustrating an exemplary process for implementing network operation and information processing, according to one or more embodiments of the present invention.

FIG. 3 is a flow chart illustrating an exemplary process for implementing network operation and information processing, according to one or more embodiments of the present invention.

FIG. 4 is a flow chart illustrating an exemplary process for implementing network operation and information processing, according to one or more embodiments of the present invention.

FIG. 5 is a flow chart illustrating an exemplary process for implementing network operation and information processing, according to one or more embodiments of the present invention.

FIG. 6 is a flow diagram illustrating an exemplary process for implementing network operation and information processing, according to one or more embodiments of the present invention.

FIG. 7 is a flow diagram illustrating an exemplary process for implementing network operation and information processing, according to one or more embodiments of the present invention.

FIG. 8 is a flow chart illustrating an exemplary process for implementing network operation and information processing, according to one or more embodiments of the present invention.

FIG. 9 is a flow diagram illustrating an exemplary process for implementing network operation and information processing, according to one or more embodiments of the present invention.

FIG. 10 is a flow diagram illustrating an exemplary process for implementing network operation and information processing, according to one or more embodiments of the present invention.

### DESCRIPTION OF THE EMBODIMENTS

Reference will now be made in detail to embodiments of the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Many systems and environments are used in connection with networks, network operation, and associated information processing. These systems and environments can be implemented with a variety of components, including various permutations of the hardware, software, and firmware disclosed below. Exemplary system architecture for the embodiments of systems and methods of network operation and information processing disclosed throughout this specification is set forth as follows.

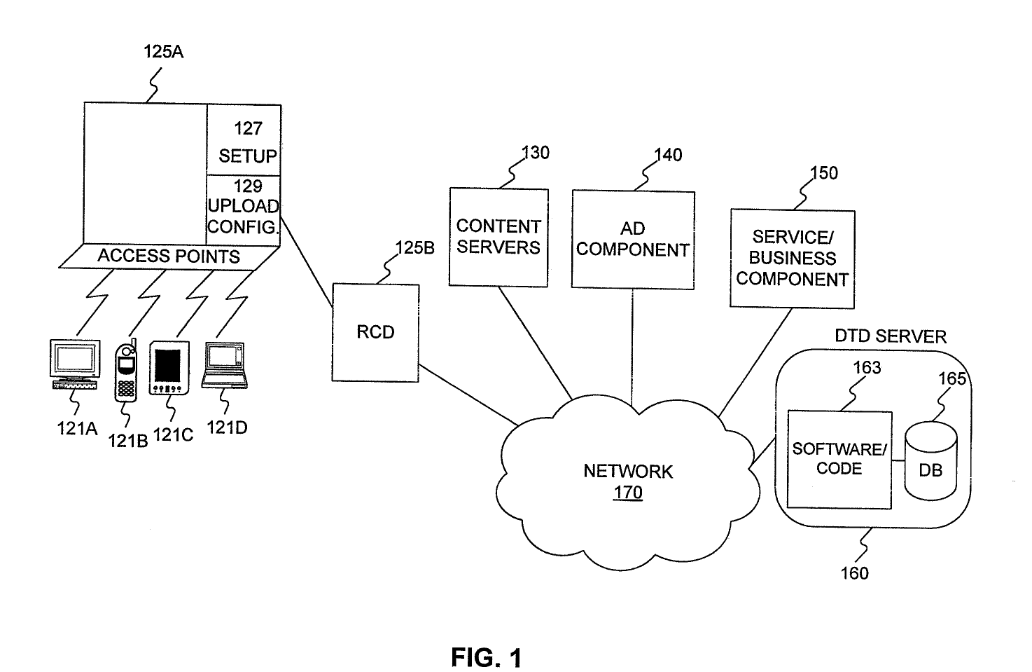

FIG. 1 illustrates a block diagram of an exemplary system consistent with one or more embodiments of the present invention. While the description of FIG. 1 is directed to the following exemplary hardware and software elements, the components of the system can be implemented through any suitable unitary or distributed combination of hardware, software and/or firmware. Referring to FIG. 1, the illustrated system includes access devices 121A-121D, one or more components such as Routing/Connectivity Devices (RCDs) 125A and 125B, and a processing component such as a Device and Targeting Database Server (“DTD Server” or “DTDS”) 160, typically connected via a network 170 such as the World Wide Web. Data processing between the RCDs 125A and 125B, the access devices 121A-121D and their users, and the DTD Server 160, over the network 170, is used to implement various aspects of user engagement, user identification and user profiling functionality disclosed herein. For example, a request, associated with a user of an access device 121A-121D, for authorization to use the network may be transmitted from access devices 121A-121D to the DTD Server 160. Similarly, first data in reply to this request may be transmitted via DTD Server 160 back to the access device 121A-121D. As used herein, “first data” refers to initial data, information, pages and/or content intended for transmission to user access device, including but not limited to pages such as initial pages, splash pages, home pages, terms & conditions pages, acceptance pages, first pages, and/or other pages, as well as other information of relevance based on user-specific information. Further, any combinations of these pages and this information may be served to accomplish various objectives such as to minimize page transmission, to present ads or other desired material, to provide information targeted to the specific used, and/or to effect a logical order of any other user interaction addressed herein.

In the exemplary embodiment illustrated in FIG. 1, the Routing/Connectivity Device is comprised of a first RCD component 125A (e.g., an access point) and a second RCD component 125B (e.g., a gateway, a router, etc.), although the RCD may readily be implemented as a unitary or otherwise distributed system element(s). The first RCD component 125A may also include a setup component 127 and an upload configuration component 129, which can be customized for the particular application, location or use. DTD Server 160 may be comprised of a database 165 and a software/code component 163, although data such as user profile data may also be stored in one or more external databases. Additional elements may also be associated with the network 170, such as Content Servers 130, Ad Components 140, and Service/Business Components 150, although these components can also be integrated into or combined with other elements of the system, or eliminated altogether, according to one or more embodiments of the present invention.

The information stored in DTD server 160 such as user profile information may be updated over network 170 using information gathered by RCDs 125A and 125B from users 121 connecting with or attempting to connect to the network. In some embodiments RCD 125A may request user and device profile information from the DTD Server 160 if the particular user or device has accessed the system on a prior occasion. In some embodiments, user or device profile information may be downloaded to a local network cache (not shown) for quicker access. In some embodiments, according to the present invention, multiple DTD servers may be used and physically and geographically distributed across network 170. According to one or more embodiments of the present invention, a processing component such as DTD Server 160 is associated with the public-access network. In this context, “associating” means that the processing device: (1) has been or is presently connected to the network, either physically or functionally in a manner allowing data exchange, (2) is involved in activating a new connection between the processing component and the network, or activating one that already exists, or (3) enables or commences processing consistent with the methodologies disclosed herein. Further, processing software is “associated” with the processing component in that it can either be physically contained within or connected to the processing component, or that it may be a distributed element located elsewhere on the network. Network 170 could be a LAN, WAN or the Internet. Further, a request for authorization to use a network is associated with a user of an access device in that the request may either be an explicit instruction of the user or it may simply be the result of the user's innate access device functionality. In some embodiments, the RCD 125 could be consistent with existing access point (“AP”) systems such as remote wireless access points/servers from generic providers, for example, Proxim, Linksys, Dlink, Compex, Buffalo Technologies, Netgear, Terabeam, Nomadix, and Plug Inn Go, etc. In some embodiments, the present information processing system may also be used or implemented with wired technology. Embodiments of the present system may also include signal amplifiers, external antennas, signal splitters, and other standard equipment as components.

In some embodiments, the servers and related systems shown in FIG. 1 may be standard off-the-shelf components or server class computers. For example, the DTD Server 160 of the present invention may be implemented with, for example, Microsoft's (“MS”) SQL Server, and the web server can be a MS IIS server. Additionally, any other programs or code capable of accessing and/or providing information in the database may also be used. In further embodiments, the system, servers, and/or system elements may use languages such as SQL, XML, SOAP, ASP, and HTTP, etc., to enable data transmission and processing, although any suitable programming language or tool could also be used.

Systems and methods of the present invention can be implemented on a variety of networks, including wireless networks such as WiFi, WiMAX, and any mobile Ethernet network. Systems and methods can also be implemented on wired and other networks, such as Cable, DSL and Fiber-based broadband networks, or any combinations of wired and wireless networks (e.g. combined Cable+WiFi). Certain embodiments of the present invention, as set forth herein, pertain to wireless/WiFi systems (not limited to varieties of WiFi 802.11b/a/g/n mobile Ethernet standards) and associated methods of information processing. Referring to FIG. 1, an exemplary embodiment that may sustain an internet zone or service offered freely to the public is consistent with the system disclosed. Such a service may also be based on subscription or pre-pay charges, or some combination of carrier subsidy, consumer fees, and/or completely free access. In some cases, where the network is used for both public access and for private networks (e.g. Government, Municipal or Enterprise/Campus users), the same basic system can also be used. Systems enabling free usage, for example, may be facilitated by information processing that includes location-based services provided via ‘sponsors,’ such as commercial enterprise sponsors. These sponsors benefit from the targeted content delivery and user profiling features provided by the present systems and methods. Accordingly, these sponsors implement embodiments wherein they absorb the costs normally required of the users, According to these embodiments, an engine or server including end user authorization functionality such as provided by the DTD Server, is used to transmit commands back to RCPs (e.g., access points, etc.) or servers (e.g., ad servers, authentication servers, content servers, etc.) to open up a connection to the Internet. Such connection may be unrestricted, or it may be restricted by bandwidth limitations per user or by other limitations deemed necessary to maintain the QOS (quality of service).

The DTD Server 160 can also include central authorization software that enables the system to scale to hybrid public Internet access networks across the world by controlling the end user but having the option of not managing various remote hardware, such as a remote router. By managing the AP or server (e.g., element 125A) and not the router (e.g., element 125B) at remote locations, this remote point of entry network device can co-exist with existing deployed networks with very few barriers. For example, an existing network may have 1 megabyte pipe up and down, but the provider may benefit by allowing a free internet zone in its place of business where the unused amount of network bandwidth can be used, and so may limit the public zone with 256 kbps up and 700 kbps down, and limit each user to no more than 128 kbps up and 500 kbps down each. Further, the DTD Server site profile can be updated centrally and apply the policy when the request comes from a user, as well as to adjust the bandwidth based on time of day and any other QOS reasons.

These WiFi/UN engine embodiments collect and provide pertinent information about a user by virtue of collecting information about the access device associated with the user. Thus, the information is anonymous in the sense that it is not a profile of an individual per se, but rather information associated with a computing device they use. This information can be related to the device, the temporary or permanent software on the device, and any user-input data which is resident on the device. All these data are captured and retained, and indexed with an identifier such as MAC or other user identifier (UID) so the information from a repeat user can be verified and enhanced each time the same device accesses the network. Acquired information can be, for example, the full range of unrestricted information typically sought by commercial entities, including name, address, and other personal data. The acquired information can also be limited in its scope, as certain prohibitions may dictate that end user name, race, phone numbers, addresses, etc. are not collected/disclosed in adherence to restrictions or local laws such as those directed to privacy.

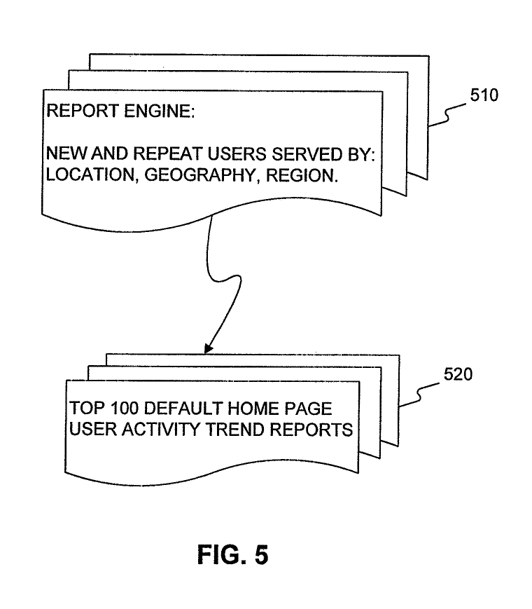

Embodiments of the system of FIG. 1 can also include a profile engine (not shown), which includes the ability to process identifier data such as MAC addresses and/or any other specific software- or hardware-based user identifier (UID). The profile engine may be a component of the DTD Server 160, though it may also be distributed anywhere within the system of FIG. 1. In one or more embodiments, the profile engine may include an algorithm designed to profile the identifier data/user based on the frequency and locations that the associated access device joins a network, coupled with other user data such as answers to survey questions and/or other user actions or responses. The calculated profile information can be correlated in the processor, weighted according to value (such as incremental numeric value), and then placed in profile groups or Pools to enable correlation with sponsors interested in that type or group of users. Pools are survey-related groupings, and are described in more detail in connection with FIG. 5, below. When a user requests to join the network, the identifier can be associated with a location tag, and the request associated with this information can be matched up with an appropriate sponsor for that location. Content highly targeted to the user is thereby enabled, including customized content from third-party databases that contain information related to the location. For example, the customized content may include information about the location itself, places, attractions, and events in the proximity of that location, as well as information related to what has happened and what will happen in that locality (e.g. historical events, future community or concert events, sale events planned at the local stores, etc.).

According to these embodiments, the profile engine can provide highly relevant, targeted information, advertising or specific services that are unique to each user from the same network. Further, repeated access to the network by a user enables the profile engine to collect more and more network usage information for the user or associated access device. Additionally, the profile engine may also determine trend rates per geographic zone, which is of value to advertisers in the local region or remote sponsors seeking local presence. This can allow for local advertising, local billing of services, and the ability of nationwide advertisers and brands to customize their content according to a location or groups of locations with similar characteristics (e.g. all neighborhoods in the mid-west with a local temperature of over 80 Celsius or all neighborhoods in the Pacific North-West with largely Asian ethnic demographics).

In some embodiments, when an end-user browses web sites using a computing device, the RCD 125 collects information regarding browsing habits and relays this information to DTD Server 160, where a database profile for the user and/or device may be updated. In some embodiments, the RCD 125 may also download information from DTD Server 160 and modify and send some of this information to content servers such as Content Server 130, to ad-related entities or components such as Ad Component 140, and/or to service providing entities or components such as Service/Business Component 150. In some embodiments, user and/or device profile information received by Content Server 130 from either the RCD 125 or the NDP server 160 may be used by Content Server 130 to determine which advertisements to retrieve from Ad Component 140. Content and advertising information are combined by Content Server 130 and sent to the RCD 125 for transmission to the users 121. In some embodiments, the RCD 125 may modify the content or advertising received over the network 170 based on device characteristics. For example, if client 121 is a handheld device, the format of the content may be modified to better suit the screen and other characteristics of that handheld device.

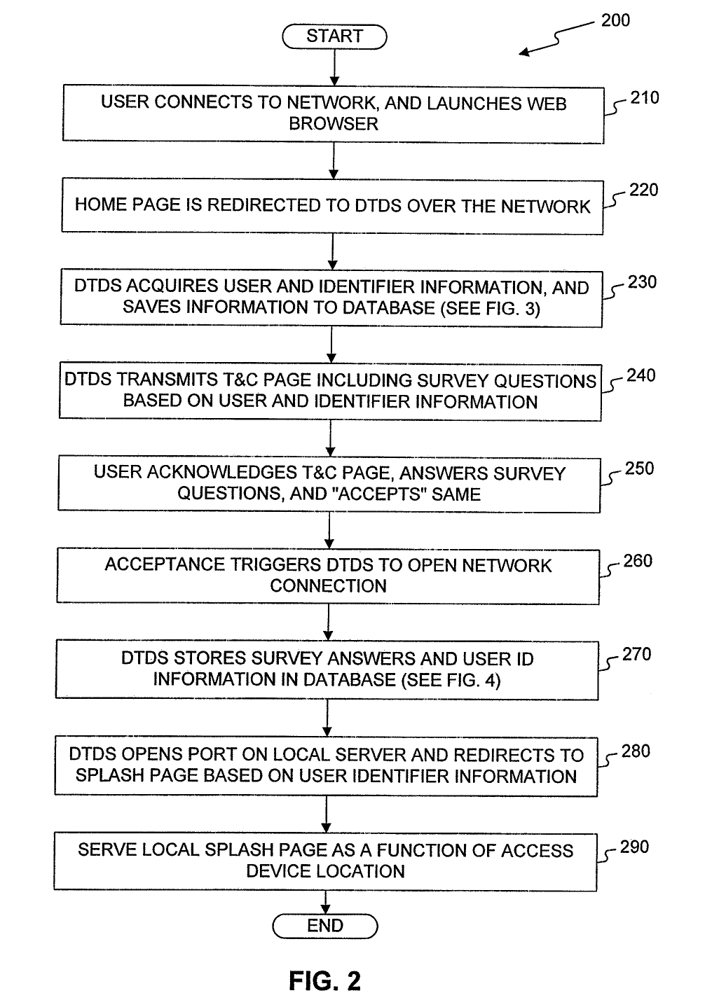

Furthermore, the above-described systems may also include various system reporting features and functionality. For example, identifier information such as MAC and UID may be used to track a user as they travel from location to location, and an identifier algorithm engine may be used to process and provide other identifier-related information. According to these embodiments, the identifier algorithm engine can register the identifier in a database, including the time(s) of use, the AP (access point) location, and the user profile. Specific illustrations of this functionality are set forth in connection with FIGS. 2-10, below.

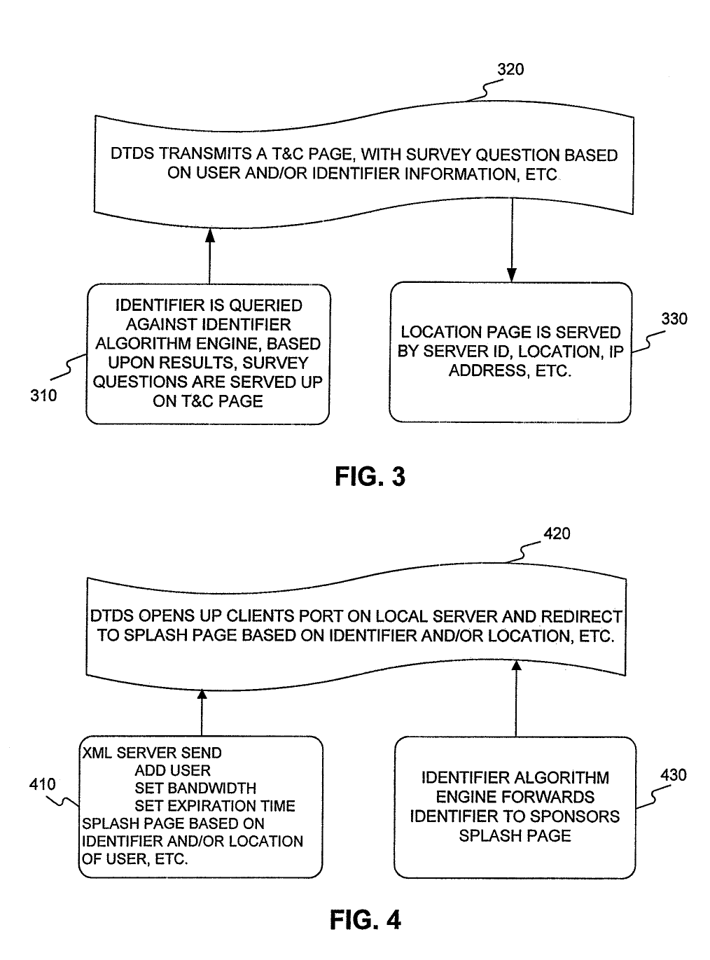

FIG. 2 depicts an exemplary flowchart with steps 200 consistent with one or more embodiments of the present invention. Referring to FIG. 2, a method of collecting and processing information consistent with certain aspects related to the present invention is illustrated. As shown in FIG. 2, an end-user first connects to a public network and launches a web browser (step 210). The browser is not allowed to access the default home page of the computing device, but rather is redirected to the DTD Server 160 over the network (step 220). Beginning with this very first handshake/data exchange whether through hypertext markup, radius accounting records, or back-channel communication, the DTD Server 160 acquires user profile and user identifier information, and begins saving this information to a database, this information can be new or simply building upon existing an existing profile (step 230). The profile protects user anonymity by using the UID as a proxy for the individual The information stored in the database may be, inter alia, time/date information, initial home and/or default page information, location information such as that derived from the server or access point IP address or ID, specific identifier information for the user (e.g., MAC address, etc.), additional information can be provided by third parties who wish exchange existing user/device information and/or store this third party information indexed by the UID for future transactional reference, as well as any other information acquired by the DTD Server 160 at this time. As a result of survey and profile engine processing (as detailed in connection with FIG. 3, below, and elsewhere), survey questions specific to each user are generated based upon the acquired information. DTD Server 160 then transmits first data such as a terms and conditions (T&C) page with these survey questions to the user (step 240). The user may then answer the survey questions and acknowledge the terms and conditions, for example, by selecting an “accept” button (step 250). In response to receipt of this acceptance, the DTD Server 160 can open or instruct the network equipment to open a network connection for the user (step 260). The DTD Server 160 also then stores the survey answers as well as any new or related user identifier information in a database (step 270). Additional processing related to this new (e.g., survey) information is performed by the DTD Server 160, as set forth in connection with FIG. 4. As a function of this additional processing, the DTD Server 160 opens up (or instructs network hardware to open) a client port on the local server and redirects the user to a splash page (also known as landing page) determined as a function of user identifier information with components customized for that individual (step 280). Suitable splash pages may be retrieved and stored in network cache. Finally, a local splash page, determined as a function of the access device location, is sent to the user's browser (step 290). Furthermore, all of the content transmitted to the user (e.g., first data, splash pages, etc.) may be formatted and/or indexed to the specific type of access device utilized by the user, as determined by the DTD Server 160. The cumulative profile generated by DTD can be accessed for future use during that session or sessions that follow.

FIG. 3 shows an exemplary technique regarding how information including survey questions may be generated, transmitted, and processed, according to one or more embodiments of the invention. First, the identifier is queried against an identifier algorithm engine 310 to determine if a profile exists for that user and, if so, which survey questions the user has already answered. Based on location, stored user profile information, and user responses, the DTD Server may decide to serve additional, unanswered survey questions. As a function of these determinations, any outstanding survey questions are associated with the terms and conditions (T&C) page. The DTDS 160 then transmits the T&C page with the survey questions 320. A location page may also be served as a function of server ID, location, IP address, etc. 330. In some embodiments, the information received typically enables the Profile Engine to serve up targeted advertisements (e.g., banner ads, rich media, video, audio, and other content keyed to user information such as location, user profile information, etc.), sponsor logos, and pages such as first pages, splash pages, etc.

FIG. 4 shows another exemplary technique regarding how information may be collected and processed when an XML gateway or Radius based implementation is used, according to one or more embodiments of the invention. As shown in FIG. 4, an XML Serving component of the DTD server may forward information such as identifier information (e.g., the MAC address of the access device), the bandwidth allowed to the user, and a session expiration time to the DTD Server 410. The DTD Server then opens up a port on the local server and redirects the browser to a splash page based on identifier and location information 420. The DTD Server may also retrieve user identifier information and downloads a splash page and local advertising information based on the associated user profile 430. DTD Server 160 may also access port numbers of the XML component to implement separate channels for acquiring or providing data to/from end users, advertisers, and content providers via this “back-door” technique. Radius server component could also accomplish similar data acquisition or provision based on Radius records that exist in a Radius-based environment, such as log-in files and history. However, in some embodiments of the present invention, intra-cell blocking to prevent client-to-client snooping is accomplished using without-radius technology.

FIG. 5 illustrates other data gathering and reporting functions performed by one or more embodiments of the present invention. In some embodiments, aggregate information may be collected by a report engine, such as the number of new and repeat users at a given location 510. The report engine may parse these new and repeat user statistics according to location, geography, region, and other characteristics of user service. In some embodiments, a list of user-activity trend reports may be generated such as, for example, the top 100 default home pages used by users 520. Such trend information could be used to target potential web sites or advertisers to generated revenue for the UN network and targeted content delivery service. A simple profile can be created without knowing any personal information of an end user, but enough information may complied by eventually to offer relevant content based on the current location and time of day the user has accessed the network. In some embodiments, Pool IDs (PIDs) are created and a user profile may be associated with multiple Pools. A Pool is a high-level survey-based grouping that may be inferred based on survey results. Sub Pool IDs may also be used to provide a hierarchical relationships for sub-groups within these Pools. Other Pool-related data that may gathered and/or stored include, a Historical Profile Pool ID, which may include the evolution history of an identifier profile (e.g., a MAC profile), a Historical Location ID & Usage Counter, Historical Survey ID & Response, Survey Results Per Location, and all other combinations of Pool-related data with any user or profile related data maintained by any of the processing components.

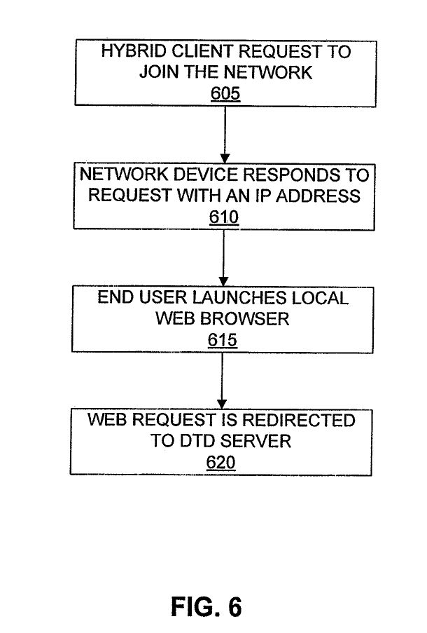

FIGS. 6-10 are flow diagrams illustrating some functionality of one or more embodiments of the present invention. Each step of embodiments of the algorithms shown in FIGS. 6-10 is demarked with a numerical identifier, 605 through 1010. The description of each step, in association with its numerical identifier, is set forth below.

In step 605, as shown in FIG. 6, a user connects to a hybrid network via any known mechanism, such as by a Wireless or an Ethernet connection. The access device (for example a PC, PDA, or Wi-Fi Phone) requests an IP address from a Routing/Connectivity or network device such as a local Dynamic Host Configuration Protocol (“DHCP”) server.

In step 610, the RCD or network device assigns an IP address to the access device. An access device identifier, such as the MAC address, is then registered in the RCD or network device and is placed in a pending status. When this identifier (i.e., MAC address, in the present example) is first seen on the network or a user registers to the system, the DTD Server instantly creates a profile ID and database record based upon this identifier information.

In step 615, the end user now launches a local web browser which makes its initial request to go to the user default home page.

In step 620, the RCD or network device intercepts the request and redirects the request to the DTD Server on the network, while also transmitting the identifier (e.g., here, MAC address), local IP address, and original home page URL, along with the network device IP address and other specific identifier information.

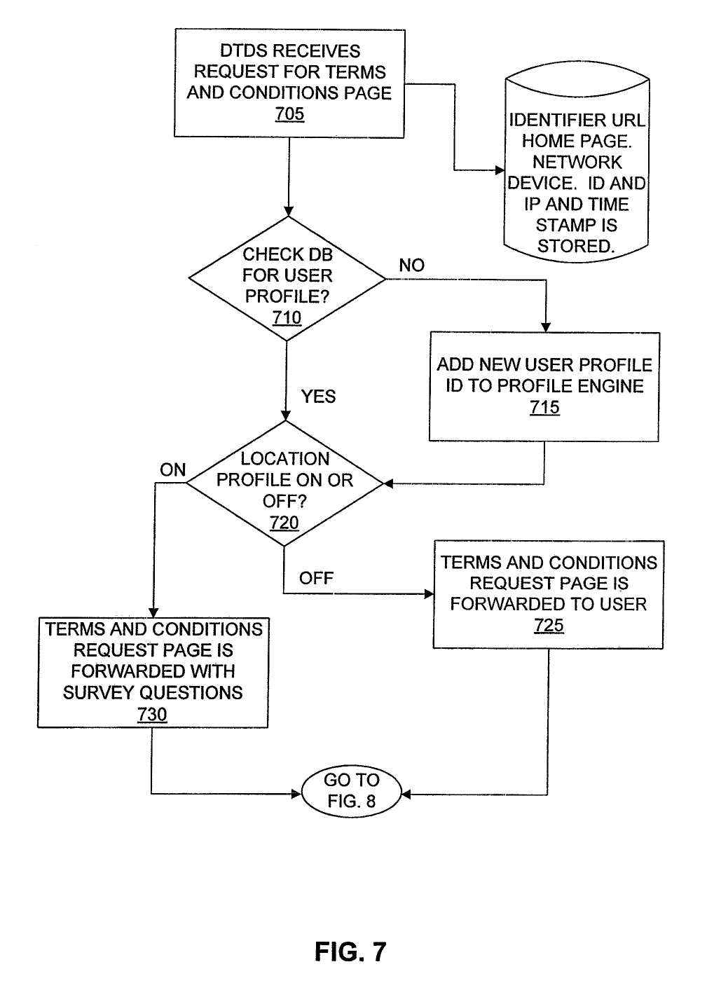

In step 705 as shown in FIG. 7, the DTD Server 160 receives a request for the local Terms & Condition (T&C) Page from the end user. During these initial exchanges, the following exemplary information may be acquired by the DTD Server and recorded in the Profile Engine: identifier information such as end user MAC Address, Local IP Address, Default Home Page URL, RCD and/or Network Device ID, Network IP Address (e.g., for RCD, Network Device, etc.), Location ID, Local Language on Computer, Operating System/Device Specific Information, Nest Requested Home Page, Survey Results, Date and Time Information, as well as other information derived from the access device, the user's behavior, or information concerning the user generated at or by the RCD.

In step 710, the DTD Server checks against the DB to see if the identifier acquired has an existing profile (profile ID) associated with it. In step 715, if there is no profile ID, then the identifier is added to the profile Engine and assigned a Profile ID.

In step 720, the location ID is checked against the location profile database to see if the profile tag is set to on or off. The profile tag is set to “off” if the identified user has an existing profile and answers to all of the survey questions are on file. If the profile engine is in need of the answers to outstanding survey questions, the profile tag is set to “on.”

In step 725, if the profile tag is set to off, then a Local T & C page is forwarded to the requesting end users browser.

In step 730, if the profile tag is set to on, the location T & C Page is matched up with the user profile ID as well as the required survey question(s), which are forwarded to the end user browser by instruction from the DTD Server. The end user would never see the same survey question asked across any location on the network, since DTD Server tracks the identifier throughout the network.

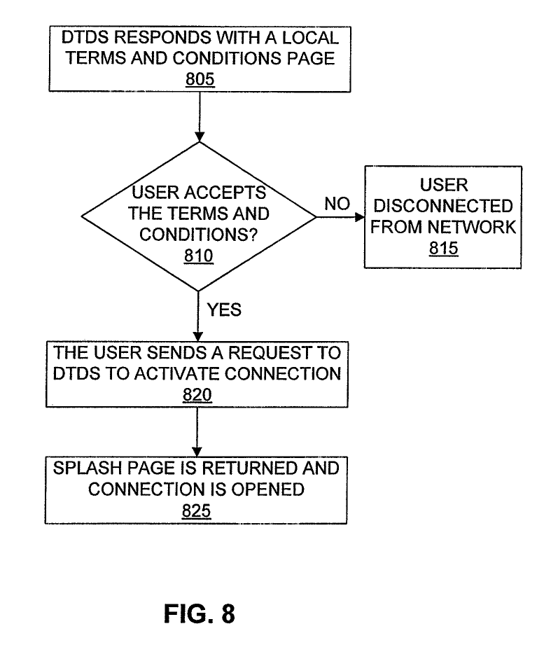

In step 805, as shown in FIG. 8, first data such as a welcome page with Terms & Conditions (T & C) is transmitted to the end user. This return page is already formatted to the device type, screen size, and format, which is/are specifically tuned to the device's capabilities.

In step 810, the end user is asked to accept or decline the T & C page condition. If a survey question is also provided here, the user has to answer the question in order to move forward.

In step 815, if the user clicks on the disagree button (regarding the T&C's), the user browser is redirected to a courtesy page requesting him or her to disconnect from the network. Alternately, a processing component may respond to a disagree selection by providing a less then full-service web experience. For example, a DTD Server may restrict the user's time or bandwidth on the network, or offer reduced guarantees of priority, traffic, and/or other performance characteristics as compared to those provided via acceptance of the terms and conditions. In some cases, these restrictions may be implemented by permitting basic web-browsing while blocking Virtual Private Networks, thus preventing a user, such as a corporate user, from accessing e-mail or using other important features associated with such networks. Restrictions may also be implemented by introducing jitter and/or delay to the extent that VoIP performance and real-time streaming of video services are not feasible or satisfactory, though browsing the web is still possible.

In step 820, if the user clicks on the Accept button, another request is sent to the DTD Server to activate a user's pending status to active status so they can now use the Internet freely. This is the unrestricted mode of using the access network, which allows the user to utilize all of the features and functionality of the Internet. However, access can still also be moderated by a pre-determined and/or real-time access control system. Such moderation or control may enable determination of the actual bandwidth and other performance characteristics contemplated. For instance, if certain identifiers have been pre-programmed within the network to restrict VPN access, then any policies of specific user access can be implemented at this stage. Next, in step 825, a splash page is transmitted to the user and a connection is opened.

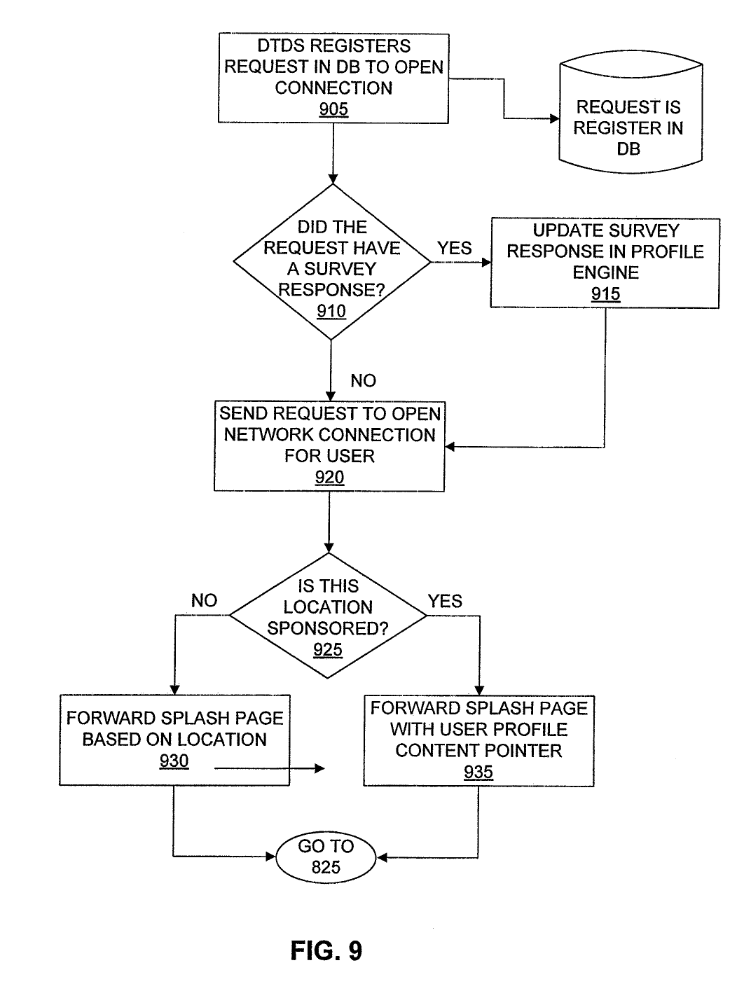

In step 905, as shown in FIG. 9, DTD Server registers the request and time of the request in an associated database. In step 910, if the request includes responses to survey answers, then they are forwarded to the Profile Engine. In step 915, survey answers are updated against data already stored for that user in the Profile Engine.

In step 920, the DTD Server now transmits some commands to the network device to activate the pending status, set the upload and download bandwidth speed per the identifier, and set an expiration time of when the user's session will expire for that network.

In step 925, the user's Location ID is checked to see if it has a sponsor associated with that location. In step 930, if there is no sponsor a generic local splash page will be sent to the requesting user. In step 935, if a sponsor is associated with that location ID based on the location profile database, a splash page with relevant local information, and a targeted advertisement based on the user's profile ID will be sent to the user.

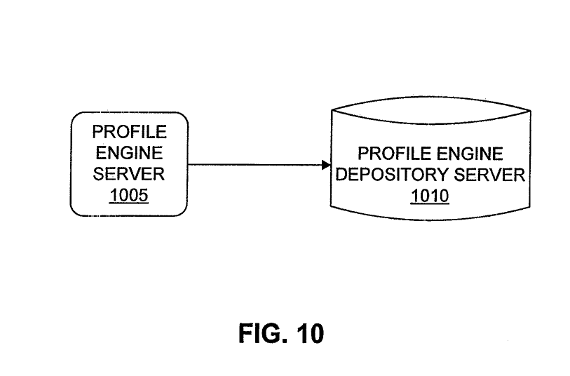

In step 1005, as shown in FIG. 10, the profile engine server performs the Profile Engine algorithms on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server, step 1010.

Regarding, in particular, the wireless implementation addressed above, the present invention provides particular advantages pertaining to direct access, location, traffic and network operations. With respect to direct access, the present invention provides direct connection to the customer and eliminates third party involvement in the delivery of content, as well as allowing for the licensee/subscriber/vendor to be the starting point of each and every communication (e.g., page, flash page, search, etc.) with the customer. With respect to location, the present invention provides the exact location of the customer, providing significantly greater value to related advertising and information. In other words, the more granular the information is about the customer, the more valuable it is to the advertisers (e.g., for directed advertising and other communications). Alternately, a more generalized location may be provided for the customer, such as region, zip code, etc., to protect user anonymity. With respect to traffic considerations, the cost methodologies addressed herein provide for greater accessibility, as costs present a significant competitive barrier. Specifically, embodiments of the present inventive methodology can provide free access by users, rather than requiring some sort of direct revenue from the end-user (although there can be fees associated with each subscription). Thus, regarding the maximization of traffic, these embodiments are particularly advantageous for networks that are: (1) carrier class, (2) easy to log onto, and (3) ubiquitous. Finally, with respect to network operations, the present methodology provides relatively low equipment costs with respect to prior network access of this nature, as well as the capability of avoiding the expenses of otherwise implementing/managing a network of this quality.

The technology set forth herein has particular applicability to the operation of WiFi networks, and especially companies closely associated with WiFi technology. The systems and methods of the present invention provide numerous advantages in the areas of network management and operation, data collection and aggregation, real-time provision of user demographics, location and other information, and reporting of WiFi network usage (summaries, aggregates, even real-time). For example, the WiFi embodiments have specific applicability to service providers, portals, and internet ad intermediaries.

For example, these WiFi embodiments provide unique advantages to service providers like VoIP (voice over IP) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). These WiFi embodiments also provide significant advantages to portals, such as real-time user demographics and location that allow for immediate, directed advertising. These WiFi embodiments also provide significant advantages to internet ad intermediaries, such as information management applicable to all of the many layers of service providers involved in having an ad (e.g., banner) displayed on a web page.

In another exemplary implementation, the present invention may help prevent click-fraud, or other activity of interest performed by users of the network. Here, the DTD server 160 has information about identifiers (such as MAC addresses) of every device on the network. This information can be associated with the cumulative number of clicks (on advertisements, marketing media etc), which can then be used to trigger a further audit if there is an anomalous number of clicks. This may allow an operator of the network, for example, to provide information about such anomalous behavior. This can be important, as the total number of clicks can be also traced to the number of clicks on a particular website and/or a particular advertiser's advertisements or content. As a result, the invention can be used as both an alerting mechanism and then a tracing mechanism to monitor and prevent click-fraud. In addition, if it is required, access to the network can be blocked for the offending device based on its identifier, so the user cannot access the network and continue with fraudulent or non-compliant practices.

In a further exemplary implementation, the present invention may also provide benefit in the areas of security and access control. Again, since user identifiers (such as MAC address) are known in the network, they can be mapped into dynamic databases which are used as a secondary mechanism of physical machine verification for access to networks, websites, and/or specific classes of digital content on a network or networks. Since the DTD Server has a database of all devices, it can interface with a large number of third-party databases. For example, it can interface with databases of allowed users who have high priority for access to the network in case of an emergency response situation, such as one directed, for example, to the whole network or just to a specific geographic location. Therefore, multiple classes of access, rules, syntax, and associations of such databases are done inside the DTD Server, enabling the network to develop intelligent rules for access to services and content based on unique combinations of these databases, and apply them to the identifier of the device.

In yet another exemplary implementation, the present invention may also provide benefit in the area of rule-based blocking of content. Specifically, the DTD Server may be employed to ensure that “no” content is delivered when none is desired. This functionality may be applicable, for example, when a network TV broadcast is scheduled for particular show times in certain regions in the world, or when movies and other digital content, such as music, are released in a carefully controlled fashion in a network. By having rules associated with content of this type, the DTD Server can determine if the user has the rights to receive and play the appropriate content. Such rights not being based solely on traditional DRM techniques, but rather on the time, location, and other parameters that the content provider can specify. For example, if an online program is released in Australia, with a release time scheduled hours later in New York, then the content provider can tag the content such that it cannot be downloaded and/or played until the appropriate release time determined by the content creator/distributor. Utilization of specific user identifiers ensures a layer of digital rights management enforceable via the network by association of the identifier and the DTD Server, by virtue of database interfaces, with the content rights and rules to be enforced by the content distributor.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention.

We claim:

1. A method of engaging users of a public-access network, the method comprising:
associating a processing component, having associated therewith processing software, with the public-access network;
transmitting a request, associated with a user of an access device, for authorization to use the public-access network, including transmission, in connection with the request, of an IP address of the user access device;
transmitting first data including a splash page, wherein the data to be transmitted is determined by the processing software as a function of the IP address;
opening up a connection to the network for the user.

2. The method of claim 1, wherein the function cross references an IP address of a Routing/Connectivity Device (RCD) with a database to determine a geographic location.

3. The method of claim 1, wherein the first data includes a MAC address of a computing device associated with the user.

4. The method of claim 1, wherein the first data includes an access device ID.

5. The method of claim 1, wherein the first data includes information indicative of a geographic location associated with the user or the access device.

6. The method of claim 1, further comprising determining usage-related information including one or more of usage frequency, usage patterns, length of session, time of use, local user usage, and/or visiting user usage.

7. The method of claim 1, further comprising one or both of determining and maintaining user information including real-time historical records.

8. The method of claim 1, further comprising authenticating the user to increase security or integrity of user activity associated with the network.

9. The method of claim 1, further comprising delivering location-specific or location-based data/information relating to business/commercial interests (e.g., advertisements, etc.).

10. The method of claim 1, wherein the splash page includes sponsor media associated with a sponsor.

11. The method of claim 10, wherein the function cross references an IP address of a Routing/Connectivity Device (RCD) with a database to determine a geographic location.

12. The method of claim 10, wherein the first data includes a MAC address of a computing device associated with the user.

13. The method of claim 10, wherein the first data includes an access device ID.

14. The method of claim 10, wherein the first data includes information indicative of a geographic location associated with the user or the access device.

15. The method of claim 10, further comprising determining usage-related information including one or more of usage frequency, usage patterns, length of session, time of use, local user usage, and/or visiting user usage.

16. The method of claim 10, further comprising one or both of determining and maintaining user information including real-time historical records.

17. The method of claim 10, further comprising authenticating the user to increase security or integrity of user activity associated with the network.

18. The method of claim 10, further comprising collecting user information and building profiles for specific users based on the user information.

19. The method of claim 10, further comprising delivering location-specific or location-based data/information enabling commercial interaction (e.g., advertisements, etc.).

20. A method of engaging users of a public-access network, the method comprising:
associating a processing component, having associated therewith processing software, with the public-access network;
transmitting a request, associated with a user of an access device, for authorization to use the public-access network, including transmission, in connection with the request, of an IP address of the user access device;
transmitting first data including information based on a location of the access device, wherein the first data is determined by the processing software as a function of the IP address;
opening up a connection to the network for the user.

21. The method of claim 20, wherein the function cross references an IP address of a Routing/Connectivity Device (RCD) with a database to determine a geographic location.

22. The method of claim 20, wherein the first data includes a MAC address of a computing device associated with the user.

23. The method of claim 20, wherein the first data includes an access device ID.

24. The method of claim 20, wherein the first data includes information indicative of a geographic location associated with the user or the access device.

25. The method of claim 20, further comprising determining usage-related information including one or more of usage frequency, usage patterns, length of session, time of use, local user usage, and/or visiting user usage.

26. The method of claim 20, further comprising one or both of determining and maintaining user information including real-time historical records.

27. The method of claim 20, further comprising authenticating the user to increase security or integrity of user activity associated with the network.

28. The method of claim 20, further comprising collecting user information and building profiles for specific users based on the user information.

29. The method of claim 20, further comprising delivering location-specific or location-based data/information enabling commercial interaction (e.g., advertisements, etc.).

30. A method of engaging users of a public-access network, the method comprising:
associating a processing component, having associated therewith processing software, with the public-access network;
transmitting a request, associated with a user of an access device, for authorization to use the public-access network, including transmission, in connection with the request, of identifier information for the user that includes an IP address of the user access device;
transmitting first data including information based on a location of the access device, wherein the first data is determined by the processing software as a function of the IP address;
opening up a connection to the network for the user.

31. The method of claim 30, wherein the function cross references an IP address of a Routing/Connectivity Device (RCD) with a database to determine a geographic location.

32. The method of claim 30, wherein the first data includes a MAC address of a computing device associated with the user.

33. The method of claim 30, wherein the first data includes an access device ID.

34. The method of claim 30, wherein the first data includes information indicative of a geographic location associated with the user or the access device.

35. The method of claim 30, further comprising determining usage-related information including one or more of usage frequency, usage patterns, length of session, time of use, local user usage, and/or visiting user usage.

36. The method of claim 30, further comprising one or both of determining and maintaining user information including real-time historical records.

37. The method of claim 30, further comprising authenticating the user to increase security or integrity of user activity associated with the network.

38. The method of claim 30, further comprising collecting user information and building profiles for specific users based on the user information.

39. The method of claim 30, further comprising delivering location-specific or location-based data/information enabling commercial interaction (e.g., advertisements, etc.).

40. A method of engaging users of a public-access network, the method comprising:
associating a processing component, having associated therewith processing software, with the public-access network;
transmitting a request, associated with a user of an access device, for authorization to use the public-access network, including transmission, in connection with the request, of an IP address of the user access device;
transmitting first data including terms/conditions information related to use of the network, wherein the data to be transmitted is determined by the processing software as a function of the IP address;
opening up a connection to the network for the user.

41. The method of claim 40, wherein the function cross references an IP address of a Routing/Connectivity Device (RCD) with a database to determine a geographic location.

42. The method of claim 40, wherein the first data includes a MAC address of a computing device associated with the user.

43. The method of claim 40, wherein the first data includes an access device ID.

44. The method of claim 40, wherein the first data includes information indicative of a geographic location associated with the user or the access device.

45. The method of claim 40, further comprising determining usage-related information including one or more of usage frequency, usage patterns, length of session, time of use, local user usage, and/or visiting user usage.

46. The method of claim 40, further comprising one or both of determining and maintaining user information including real-time historical records.

47. The method of claim 40, further comprising authenticating the user to increase security or integrity of user activity associated with the network.

48. The method of claim 40, further comprising collecting user information and building profiles for specific users based on the user information.

49. The method of claim 40, further comprising delivering location-specific or location-based data/information enabling commercial interaction (e.g., advertisements, etc.).

50. A method of engaging users of a public-access network, the method comprising:
associating a processing component, having associated therewith processing software, with the public-access network;
transmitting a request, associated with a user of an access device, for authorization to use the public-access network, including transmission, in connection with the request, of user login information;
transmitting first data including a splash page, wherein the data to be transmitted is determined by the processing software as a function of the user login information;
opening up a connection to the network for the user.

51. The method of claim 50, wherein the user login information includes user name and password information.

52. The method of claim 50, wherein the function cross references the user login information with a database to determine a geographic location.

53. The method of claim 50, wherein the first data includes a MAC address of a computing device associated with the user.

54. The method of claim 50, wherein the first data includes an access device ID.

55. The method of claim 50, wherein the first data includes information indicative of a geographic location associated with the user or the access device.

56. The method of claim 50, further comprising determining usage-related information including one or more of usage frequency, usage patterns, length of session, time of use, local user usage, and/or visiting user usage.

57. The method of claim 50, further comprising one or both of determining and maintaining user information including real-time historical records.

58. The method of claim 50, further comprising authenticating the user to increase security or integrity of user activity associated with the network.

59. The method of claim 50, further comprising delivering location-specific or location-based data or information relating to business/commercial interests (e.g., advertisements, etc.).

60. The method of claim 50, wherein the splash page includes sponsor media associated with a sponsor.

61. The method of claim 60, wherein the function cross references the user login information with a database to determine a geographic location.

62. The method of claim 60, wherein the first data includes a MAC address of a computing device associated with the user.

63. The method of claim 60, wherein the first data includes an access device ID.

64. The method of claim 60, wherein the first data includes information indicative of a geographic location associated with the user or the access device.

65. The method of claim 60, further comprising determining usage-related information including one or more of usage frequency, usage patterns, length of session, time of use, local user usage, and/or visiting user usage.

66. The method of claim 60, further comprising one or both of determining and maintaining user information including real-time historical records.

67. The method of claim 60, further comprising authenticating the user to increase security or integrity of user activity associated with the network.

68. The method of claim 60, further comprising collecting user information and building profiles for specific users based on the user information.

69. The method of claim 60, further comprising delivering location-specific or location-based data or information enabling commercial interaction (e.g., advertisements, etc.).

70. A method of engaging users of a public-access network, the method comprising:
associating a processing component, having associated therewith processing software, with the public-access network;
transmitting a request, associated with a user of an access device, for authorization to use the public-access network, including transmission, in connection with the request, of user login information;
transmitting first data including information based on a location of the access device, wherein the first data is determined by the processing software as a function of the user login information;
opening up a connection to the network for the user.

71. The method of claim 70, wherein the function cross references the user login information with a database to determine a geographic location.

72. The method of claim 70, wherein the first data includes a MAC address of a computing device associated with the user.

73. The method of claim 70, wherein the first data includes an access device ID.

74. The method of claim 70, wherein the first data includes information indicative of a geographic location associated with the user or the access device.

75. The method of claim 70, further comprising determining usage-related information including one or more of usage frequency, usage patterns, length of session, time of use, local user usage, and/or visiting user usage.

76. The method of claim 70, further comprising one or both of determining and maintaining user information including real-time historical records.

77. The method of claim 70, further comprising authenticating the user to increase security or integrity of user activity associated with the network.

78. The method of claim 70, further comprising collecting user information and building profiles for specific users based on the user information.

79. The method of claim 70, further comprising delivering location-specific or location-based data or information enabling commercial interaction (e.g., advertisements, etc.).

80. A method of engaging users of a public-access network, the method comprising:
associating a processing component, having associated therewith processing software, with the public-access network;
transmitting a request, associated with a user of an access device, for authorization to use the public-access network, including transmission, in connection with the request, of identifier information for the user that includes user login information;
transmitting first data including information based on a location of the access device, wherein the first data is determined by the processing software as a function of the user login information;
opening up a connection to the network for the user.

81. The method of claim 80, wherein the function cross references the user login information with a database to determine a geographic location.

82. The method of claim 80, wherein the first data includes a MAC address of a computing device associated with the user.

83. The method of claim 80, wherein the first data includes an access device ID.

84. The method of claim 80, wherein the first data includes information indicative of a geographic location associated with the user or the access device.

85. The method of claim 80, further comprising determining usage-related information including one or more of usage frequency, usage patterns, length of session, time of use, local user usage, and/or visiting user usage.

86. The method of claim 80, further comprising one or both of determining and maintaining user information including real-time historical records.

87. The method of claim 80, further comprising authenticating the user to increase security or integrity of user activity associated with the network.

88. The method of claim 30, further comprising collecting user information and building profiles for specific users based on the user information.

89. The method of claim 80, further comprising delivering location-specific or location-based data or information enabling commercial interaction (e.g., advertisements, etc.).

90. A method of engaging users of a public-access network, the method comprising:
associating a processing component, having associated therewith processing software, with the public-access network;
transmitting a request, associated with a user of an access device, for authorization to use the public-access network, including transmission, in connection with the request, of user login information;
transmitting first data including terms/conditions information related to use of the network, wherein the data to be transmitted is determined by the processing software as a function of the user login information;
opening up a connection to the network for the user.

91. The method of claim 90, wherein the function cross references an IP address of a Routing/Connectivity Device (RCD) with a database to determine a geographic location.

92. The method of claim 90, wherein the first data includes a MAC address of a computing device associated with the user.

93. The method of claim 90, wherein the first data includes an access device ID.

94. The method of claim 90, wherein the first data includes information indicative of a geographic location associated with the user or the access device.

95. The method of claim 90, further comprising determining usage-related information including one or more of usage frequency, usage patterns, length of session, time of use, local user usage, and/or visiting user usage.

96. The method of claim 90, further comprising one or both of determining and maintaining user information including real-time historical records.

97. The method of claim 90, further comprising authenticating the user to increase security or integrity of user activity associated with the network.

98. The method of claim 90, further comprising collecting user information and building profiles for specific users based on the user information.

99. The method of claim 90, further comprising delivering location-specific or location-based data or information enabling commercial interaction (e.g., advertisements, etc.).

100. The method of any of claims 1-99, wherein intra-cell blocking to prevent client-to-client snooping is accomplished using without-radius technology.

101. The method of any of claims 1-100, further comprising deploying and/or implementing an access device (i.e., access point, server, etc.) into the network.

102. The method of any of claims 1-101, further comprising routing and/or redirecting the user's network traffic, at least initially, to a specified processing node.

103. The method of any of claims 1-102, wherein the first data includes pages such as initial pages, splash pages, home pages, terms & conditions pages, acceptance pages, first pages, and/or other pages, with any combinations of these pages being served to accomplish various objectives such as to minimize page transmission, to present ads or other desired material, to provide information targeted to the specific used, and/or to effect a logical order of any other user interaction addressed herein.

104. The method of any of claims 1-103, further comprising transmitting instruction regarding bandwidth and/or expiration time for the connection.

105. The method of any of claims 1-104, wherein the processing software determines user/usage-related information, such as frequency of use and usage patterns, such as length of session, whether the user is a visiting or local person, time and frequency of use/usage, and/or other usage-related statistics.

106. The method of any of claims 1-105, further comprising information-processing functionality such as logging and billing, bandwidth control, and quality of service.

107. The method of any of claims 1-106, further comprising collection and/or parsing of selected or all the collected data to a third party applications vendor to enable applications which can leverage, target and/or filter any combination of the data collected with specific features of the application (e.g., a location based, time of day, weather dependent application targeted to the type of user defined by the usage behavior of the individual user).

108. The method of any of claims 1-107, further comprising building profiles of a specific user based on the cumulative class of information collected.

109. The method of any of claims 1-108, further including one or both of identifier or MAC address filtering, blocking, and/or enabling for VoIP service.
